(19) United States
(12) Patent Application Publication
(10) Pub. No.: US 2026/0011115 A1
(43) Pub. Date: Jan. 8, 2026

(54) Selective Analysis of Images for Summarization

(71) Applicant: QUALCOMM Incorporated, San Diego, CA (US)

(72) Inventors: Jonathan KIES, Encinitas, CA (US); Scott BEITH, Carlsbad, CA (US); Robert TARTZ, Imperial Beach, CA (US); Jason TAM, Irvine, CA (US)

(21) Appl. No.: 18/762,374

(22) Filed: Jul. 2, 2024

(51) Int. Cl. G06V 10/70; G06F 9/50; H04L 67/306

(52) U.S. Cl. CPC G06V 10/70; G06F 9/5044; H04L 67/306

(57) ABSTRACT

Various embodiments include computing devices and methods for managing and analyzing digital images in the computing device. Various embodiments may include selecting an image from a plurality of images, determining a processing priority for the selected image, and generating a summary for the selected image. The methods may further include customizing the generated summary to provide a customized summary based on one or more subjects in the image, a user profile, user relationships to the one or more subjects in the image, and user-based context information. The methods may further include updating metadata associated with the selected image based on the customized summary and storing the selected image and associated metadata in memory.

### BACKGROUND

Cellular and wireless communication technologies have grown exponentially over the past several years. Smartphones now serve as mobile cameras and photo repositories, leading users to frequently search for specific photos among hundreds stored on their devices. Photos often include metadata such as date and location, which aids in finding particular images. Without this metadata, users may be required to manually scan through their photos.

Concurrent with these trends, advancements in artificial intelligence (AI) and machine learning (ML) have led to the development of models that are highly adept at interpreting intricate data structures. Large Generative AI Models (LXMs) now have applications in a myriad of fields, from natural language processing to computer vision and auditory data interpretation. The efficacy of these LXMs stems from their advanced learning mechanisms, honed through training on expansive datasets, allowing them to achieve a broad spectrum of understanding and applicability. Within this broad category, Large Language Models (LLMs) have garnered particular interest for their capabilities in both comprehending and generating human language. Large Speech Models (LSMs) form another notable subclass of LXMs, specializing in processing auditory information for tasks such as speech-to-text conversion and voice identification. Large Vision Models (LVMs) (which are also referred to as Language Vision Models or Vision Language Models (VLMs)) are yet another subcategory that focuses on the analysis and interpretation of visual data.

### SUMMARY

Various aspects include methods, and processing systems implementing such methods, for managing and analyzing digital images in a computing device. Various aspects may include selecting an image from a plurality of images, determining a processing priority for the selected image, generating a summary for the selected image, customizing the generated summary to provide a customized summary based on one or more subjects in the image, a user profile, user relationships to the one or more subjects in the image, and user-based context information, updating metadata associated with the selected image based on the customized summary, and storing the selected image and associated metadata in memory.

Some aspects may further include determining the processing priority for the selected image based on one or more of metadata associated with the selected image, frequency of views, frequency of shares, presence of high-priority individuals, presence of specific image types previously queried by a user, usage of each digital image as a contact picture or within significant events, edit history, album saves, image quality, image details, or social media descriptions.

Some aspects may further include: prompting a generative artificial intelligence (AI) model to generate the summary for the selected image, receiving results from the generative AI model, determining whether existing metadata is available for the selected image, and enhancing the received query results based on the existing metadata. In some aspects, prompting the generative AI model may include prompting a generative AI model executing in the computing device, or prompting a remote generative AI model.

In some aspects, customizing the generated summary to provide a custom summary may be further based on one or more of: metadata associated with the selected image, frequency of views, frequency of shares, presence of high-priority individuals, presence of specific image types previously queried by a user, usage of each digital image as a contact picture or within significant events, edit history, album saves, image quality, image details, or social media descriptions.

Some aspects may further include receiving a user-generated query about a specific image, and customizing the generated summary further based on the received user-generated query. Some aspects may further include identifying and grouping similar images, identifying redundant images in the grouped images, determining the processing priority for the selected image and generating the summary for the selected image in response to determining that the selected image is not a redundant image, and not determining a processing priority for the selected image or generating the summary for the selected image in response to determining that the selected image is a redundant image.

Some aspects may further include monitoring availability and use of battery and processing resources of the computing device, and adjusting processing schedules to balance tradeoffs between performance and resource consumption based on a result of the monitoring.

Further aspects may include a computing device having a processing system configured with processor-executable instructions to perform operations corresponding to the methods summarized above. Further aspects may include a non-transitory processor-readable storage medium having stored thereon processor-executable instructions configured to cause a processing system to perform operations corresponding to the method operations summarized above. Further aspects may include a computing device having various means for performing functions corresponding to the method operations summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a component block diagram illustrating example components in system in package (SIP) that may be included in a computing device and configured to implement some embodiments.

FIG. 2 is a component block diagram illustrating example components and operations in a system configured to implement some embodiments.

FIGS. 3 and 4 are process flow diagrams illustrating example methods of managing images in accordance with some embodiments.

FIG. 5 is a component block diagram illustrating an example computing device in the form of a laptop that is suitable for implementing some embodiments.

FIG. 6 is a component block diagram illustrating an example wireless communication device suitable for use with various embodiments.

FIG. 7 is a component diagram of an example server suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods, and computing devices and processing systems configured to implement the methods, for managing and analyzing digital images in a computing device. Various embodiment methods may include selecting an image from a plurality of images, determining a processing priority for the selected image, generating a summary for the selected image (e.g., by querying or prompting a generative AI model, etc.), customizing the generated summary to provide a customized summary based on one or more subjects in the image, a user profile, user relationships to the one or more subjects in the image, user-based context information, and the like, updating metadata associated with the selected image based on the customized summary, and storing the selected image and associated metadata in memory. In some embodiments, the methods may include using existing metadata to enhance the generated summaries. In some embodiments, the methods may include offloading processing tasks to nearby devices with more robust capabilities. In some embodiments, the methods may include continuously monitoring and adjusting resource usage for optimal performance.

In some embodiments, the methods may include determining the processing priority based on various prioritization factors. Such factors may include, for example, the metadata associated with the selected image, a frequency of views, a frequency of shares, presence of high-priority individuals (e.g., contacts, frequently called persons, etc.), presence of specific image types previously queried by a user, usage of each digital image as a contact picture or within significant events, edit history, album saves, image quality, image details, social media descriptions, and user-defined preferences and settings.

The term “computing device” is used herein to refer to herein to refer to (but not limited to) any one or all of personal computing devices, personal computers, workstations, laptop computers, Netbooks, Ultrabook, tablet computers, mobile communication devices, smartphones, user equipment (UE), personal data assistants (PDAs), palm-top computers, wireless electronic mail receivers, multimedia internet-enabled cellular telephones, media and entertainment systems, gaming systems, media players, digital video recorders, portable projectors, 3D holographic displays, wearable devices (e.g., earbuds, smartwatches, fitness trackers, augmented reality (AR) glasses, head-mounted displays, etc.), vehicle systems, automotive displays, cameras (e.g., surveillance cameras, embedded cameras), and other similar devices that include a memory for storing images and a programmable processing system that may be configured to provide the functionality of various embodiments.

The term “processing system” is used herein to refer to one or more processors, including multi-core processors, that are organized and configured to perform various computing functions. Various embodiment methods may be implemented in one or more of multiple processors within a processing system as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC’s main processor, central processing unit (CPU), microprocessor unit (MPU), arithmetic logic unit (ALU), etc. An SoC processing system also may include software for controlling integrated resources and processors, as well as for controlling peripheral devices.

The term “system in a package” (SIP) is used herein to refer to a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “neural network” is used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” is used herein to refer to a process that is performed at runtime or during the execution of the software application program corresponding to the neural network. Inference may include traversing the processing nodes in the neural network along a forward path to produce one or more values as an overall activation or overall “inference result.”

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in-between the input and final layer may be referred to as intermediate layers, hidden layers, or black-box layers.

Each layer in a neural network may have multiple inputs, and thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer and multiple preceding layers.

The term “recurrent neural network” (RNN) is used herein to refer to a class of neural networks particularly well-suited for sequence data processing. Unlike feedforward neural networks, RNNs may include cycles or loops within the network that allow information to persist. This enables RNNs to maintain a “memory” of previous inputs in the sequence, which may be beneficial for tasks in which temporal dynamics and the context in which data appears are relevant.

The term “long short-term memory network” (LSTM) is used herein to refer to a specific type of RNN that addresses some of the limitations of basic RNNs, particularly the vanishing gradient problem. LSTMs include a more complex recurrent unit that allows for the easier flow of gradients during backpropagation. This facilitates the model’s ability to learn from long sequences and remember over extended periods, making it apt for tasks such as language modeling, machine translation, and other sequence-to-sequence tasks.

The term “transformer” is used herein to refer to a specific type of neural network that includes an encoder and/or a decoder and is particularly well-suited for sequence data processing. Transformers may use multiple self-attention components to process input data in parallel rather than sequentially. The self-attention components may be configured to weigh different parts of an input sequence when producing an output sequence. Unlike solutions that focus on the relationship between elements in two different sequences, self-attention components may operate on a single input sequence. The self-attention components may compute a weighted sum of all positions in the input sequence for each position, which may allow the model to consider other parts of the sequence when encoding each element. This may offer advantages in tasks that benefit from understanding the contextual relationships between elements in a sequence, such as sentence completion, translation, and summarization. The weights may be learned during the training phase, allowing the model to focus on the most contextually relevant parts of the input for the task at hand. Transformers, with their specialized architecture for handling sequence data and their capacity for parallel computation, often serve as foundational elements in constructing large generative AI models (LXM).

The term “large generative AI model” (LXM) is used herein to refer to an advanced computational framework that includes any of a variety of specialized AI models including, but not limited to, large language models (LLMs), large speech models (LSMs), large/language vision models (LVMs), vision language models (VLMs)), hybrid models, and multi-modal models. An LXM may include multiple layers of neural networks (e.g., RNN, LSTM, transformer, etc.) with millions or billions of parameters. Unlike traditional systems that translate user prompts into a series of correlated files or web pages for navigation, LXMs support dialogic interactions and encapsulate expansive knowledge in an internal structure. As a result, rather than merely serving a list of relevant websites, LXMs are capable of providing direct answers and/or are otherwise adept at various tasks, such as text summarization, translation, complex question-answering, conversational agents, etc. In various embodiments, LXMs may operate independently as standalone units, may be integrated into more comprehensive systems and/or into other computational units (e.g., those found in a SoC or SIP, etc.), and/or may interface with specialized hardware accelerators to improve performance metrics such as latency and throughput. In some embodiments, the LXM component may be enhanced with or configured to perform an adaptive algorithm that allows the LXM to better understand context information and dynamic user behavior. In some embodiments, the adaptive algorithms may be performed by the same processing system that manages the core functionality of the LXM and/or may be distributed across multiple independent processing systems.

The term “embedding layer” is used herein to refer to a specialized layer within a neural network, typically at the input stage, that transforms discrete categorical values or tokens into continuous, high-dimensional vectors. An embedding layer may operate as a lookup table in which each unique token or category is mapped to a point in a continuous vector space. The vectors may be refined during the model’s training phase to encapsulate the characteristics or attributes of the tokens in a manner that is conducive to the tasks the model is configured to perform.

The term “token” is used herein to refer to a unit of information that a generative AI model (e.g., LXM, etc.) may read as a single input during training and inference. Each token may represent any of a variety of different data types. For example, in text-centric models such as in LLMs, each token may represent a textual element such as a paragraph, sentence, clause, word, sub-word, character, etc. In models designed for auditory data, such as LSMs, each token may represent a feature extracted from audio signals, such as a phoneme, spectrogram, temporal dependency, Mel-frequency cepstral coefficients (MFCCs) that represent small segments of an audio waveform, etc. In visual models such as LVM, each token may correspond to a portion of an image (e.g., pixel blocks), sequences of video frames, etc. In hybrid systems that combine multiple modalities (text, speech, vision, etc.), each token may be a complex data structure that encapsulates information from various sources. For example, a token may include both textual and visual information, each of which independently contributes to the token’s overall representation in the model.

There are generally limitations on the total number of tokens that may be processed by AI models. As an example, a model with a limitation of 512 tokens may alter or truncate input sequences that go beyond this specific count.

Each token may be converted into a numerical vector via the embedding layer. Each vector component (e.g., numerical value, parameter, etc.) may encode an attribute, quality, or characteristic of the original token. The vector components may be adjustable parameters that are iteratively refined during the model training phase to improve the model’s performance during subsequent operational phases. The numerical vectors may be high-dimensional space vectors (e.g., containing more than 300 dimensions, etc.) in which each dimension in the vector captures a unique attribute, quality, or characteristic of the token. For example, dimension 1 of the numerical vector may encode the frequency of a word’s occurrence in a corpus of data, dimension 2 may represent the pitch or intensity of the sound of the word at its utterance, dimension 3 may represent the sentiment value of the word, etc. Such intricate representation in high-dimensional space may help the LXM understand the semantic and syntactic subtleties of its inputs. During the operational phase, the tokens may be processed sequentially through layers of the LXM or neural network, which may include structures or networks appropriate for sequence data processing, such as transformer architectures, recurrent neural networks (RNNs), or long short-term memory networks (LSTMs).

The term “sequence data processing” is used herein to refer to techniques or technologies for handling ordered sets of tokens in a manner that preserves their original sequential relationships and captures dependencies between various elements within the sequence. The resulting output may be a probabilistic distribution or a set of probability values, each corresponding to a “possible succeeding token” in the existing sequence. For example, in text completion tasks, the LXM may suggest the possible succeeding token determined to have the highest probability of completing the text sequence. For text generation tasks, the LXM may choose the token with the highest determined probability value to augment the existing sequence, which may subsequently be fed back into the model for further text production.

The proliferation of digital imaging devices has led to an overwhelming accumulation of photos on personal computing devices. Users frequently capture hundreds, if not thousands, of images on their smartphones, making it challenging for them to manage and retrieve specific photos when needed. Traditional photo management systems rely almost exclusively on basic metadata such as date and location. Such metadata provides limited assistance in efficiently organizing and accessing images within a computing device such as a smartphone, tablet, or laptop computer. As a result, users often find themselves manually scrolling through extensive galleries of photos, which is a time-consuming and frustrating process that degrades the user experience.

In addition, many users desire to add meaningful context to their photos to enhance their ability to search and recall memories. Conventional AI-based solutions demand substantial computational, power, and memory resources and thus are not suitable for use in resource-constrained devices, such as mobile devices. In addition, the process of sending photos to remote servers for analysis may raise privacy and security vulnerabilities.

Various embodiments may include components configured to overcome these and other technical challenges by intelligently prioritizing the images to process for summarization, efficiently using available resources, intelligently offloading tasks, maintaining user privacy, and providing accurate and personalized metadata enhancements.

In some embodiments, the components may be configured to selectively analyze and summarize digital images stored on personal devices, such as mobile devices. The components may improve resource allocation and enhance the overall user experience by implementing sophisticated algorithms that prioritize images based on specific features and factors. The components may integrate existing metadata to generate comprehensive and contextually relevant image summaries that make it easier for users to find, organize, and share their visual memories.

In some embodiments, the components may be configured to determine processing priority based on various prioritization factors. These factors may include metadata associated with the selected image, frequency of views, frequency of shares, presence of high-priority individuals (e.g., contacts, frequently called persons), presence of specific image types previously queried by a user, usage of each digital image as a contact picture or within significant events, edit history, album saves, image quality, image details, and social media descriptions. The components may be configured to use these and other prioritization factors to select and process the most relevant and important images first.

In some embodiments, the components may be configured to prioritize images to be analyzed by generative AI image summarization models based on various factors to manage high costs, power needs, and frequency of analysis. These factors may include image quality (i.e., higher-quality images may receive higher priority due to their potential for providing more detailed and accurate summaries), usage by other mobile device apps (e.g., images set as contact photos, frequently sent, edited, or shared, etc.), time, date, location, facial recognition data, and information from other apps that may be used to enhance the context for each image.

In some embodiments, the components may be configured to prioritize images based on the importance of relationships depicted in the photos to the user. This may include analyzing contact information, such as speed dial entries or frequently contacted individuals, to determine relationship significance. Social media interactions, such as frequency of posts to particular people or groups, may also inform this prioritization. For example, images featuring immediate family members may receive the highest priority, followed by extended family, close friends, and other social connections.

In some embodiments, the components may be configured to evaluate prior AI image summarization queries run on an image when determining processing priority. This historical data may help in recognizing recurring patterns and applying consistent analysis criteria. In some embodiments, the components may be configured to re-use common queries on similar photos (e.g., to improve efficiency, etc.). For example, if a user queries a photo of a painting with "Who painted this?" the components may apply this query to all photos of paintings. Similarly, a query such as "What musician is playing?" may be extended to all images of musical performances to improve the analysis operations by applying learned patterns to new data.

In some embodiments, the components may be configured to overcome the cumbersome and often prohibitive computational demands of generative AI models by offloading processing tasks to nearby devices with more robust capabilities. For example, the components may transfer image processing tasks to the more powerful device if a user’s smartphone is connected to a nearby laptop or desktop computer via a local network (e.g., Wi-Fi). This may conserve battery life and reduce the overall processing time. In some embodiments, the components may be configured to facilitate this offloading process by implementing or using various offloading technologies (e.g., via Bluetooth, WiFi, or other connection technologies) to detect nearby devices and manage the necessary data transfers.

In some embodiments, the components may be configured to integrate existing metadata to improve the analysis results generated by the AI model and/or to generate more accurate and contextually relevant summaries. For example, metadata such as geotags, timestamps, and social media descriptions may provide valuable context that improves the accuracy of the generated summaries. As such, the components may be configured to, for example, determine whether a video was recorded at the same event as a still image and analyze the audio from the video to gain additional context in response to determining that a video was recorded at the same event as a still image.

In some embodiments, the components may be configured to customize the generated summaries based on user-specific information. The components may generate personalized summaries that resonate more closely with the user’s experiences and relationships by using facial recognition, user profiles, and historical data such as past queries and viewing habits. For example, instead of a generic description such as “a boy playing soccer,” the summary may include “your son playing soccer at his school’s field day.”

In some embodiments, the components may be configured to allow users to set preferences for which types of images are analyzed and summarized. The components may allow users to choose to prioritize or exclude certain images based on their content or context, such as excluding images considered private or sensitive.

In some embodiments, the components may be configured to maintain efficiency and manage resources effectively by continuously monitoring the availability and use of battery life and processing power. The components may defer or deprioritize non-critical tasks or adjust the processing schedule to balance performance with resource consumption in response to determining that a device’s resources have become limited or strained.

In some embodiments, the components may be configured to combine advanced techniques to implement a robust technical solution for managing and analyzing digital images. For example, the components may integrate any or all of the prioritization algorithms, offloading capabilities, metadata enhancement, personalized summaries, and resource management to provide a comprehensive solution that addresses the challenges of modern digital image management.

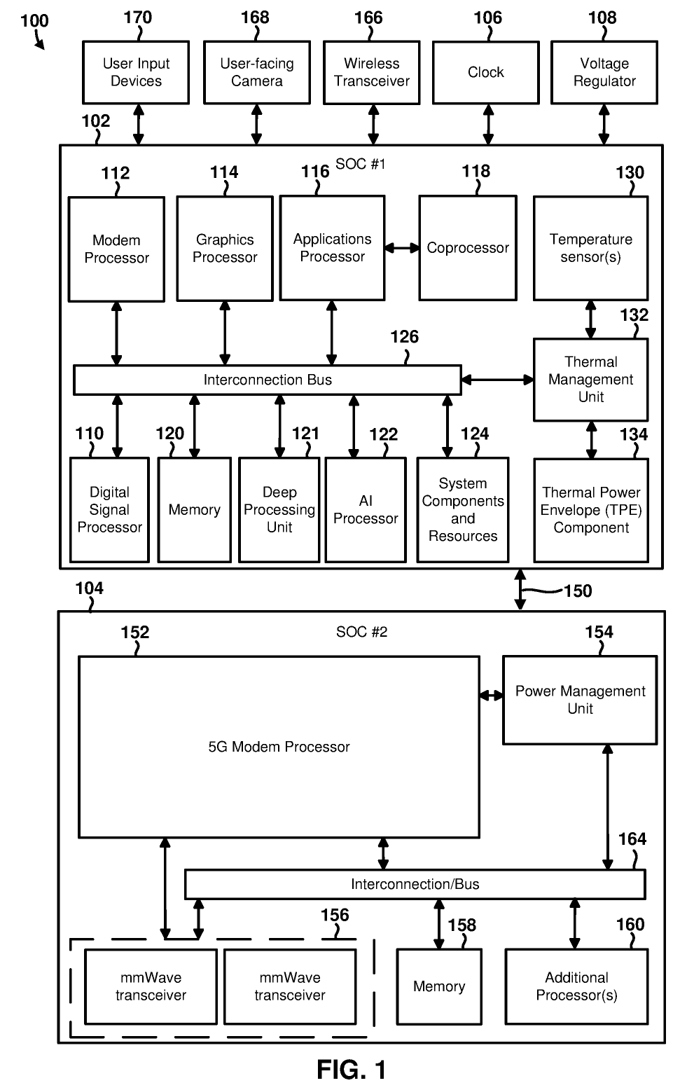

Various embodiments may be implemented on a number of single-processor and multiprocessor computer systems, including a system-on-chip (SOC) or system in a package (SIP). FIG. 1 illustrates an example computing system or SIP 100 architecture that may be used in user-end devices to implement various embodiments.

With reference to FIG. 1, the illustrated example system in package (SIP) 100 includes two System on Chips (SOCs) 102 and 104, a clock 106, a voltage regulator 108, a wireless transceiver 166, a camera 168, and user input devices 170 (e.g., a touch-sensitive display, a touchpad, a mouse, etc.). The first and second SoCs 102 and 104 may communicate via interconnection bus 150. Various processors 110, 112, 114, 116, 118, 121, and 122 may be interconnected to each other, and one or more memory elements 120, system components and resources 124, and a thermal management unit 132 via an interconnection bus 126, which may include advanced interconnects such as high-performance networks-on-chip (NOCs). Similarly, processor 152 may be interconnected to the power management unit 154, mmWave transceivers 156, memory 158, and various additional processors 160 via interconnection bus 164. These interconnection buses 126, 150, and 164 may include an array of reconfigurable logic gates and/or implement a bus architecture (e.g., CoreConnect, AMBA, etc.). Communications may be provided by advanced interconnects such as NOCs.

In various embodiments, any or all of the processors 110, 112, 114, 116, 121, and 122 in the system may operate as the SoC’s main processor, central processing unit (CPU), microprocessor unit (MPU), arithmetic logic unit (ALU), etc. One or more of the coprocessors 118 may operate as the CPU.

In some embodiments, the first SoC 102 may operate as the central processing unit (CPU) of the computing device that carries out the instructions of software application programs by performing arithmetic, logical, control, and input/output (I/O) operations specified by the instructions. In some embodiments, the second SoC 104 may operate as a specialized processing unit. For example, the second SoC 104 may operate as a specialized 5G processing unit responsible for managing high-volume, high-speed (e.g., 5 Gbps) and/or very high-frequency short wavelength (e.g., 28 GHz mmWave spectrum) communications.

The first SoC 102 may include a digital signal processor (DSP) 110, a modem processor 112, a graphics processor 114, an application processor 116, one or more coprocessors 118 (e.g., vector co-processor, CPUCP, etc.) connected to one or more of the processors, memory 120, data processing unit (DPU) 121, artificial intelligence processor 122, system components and resources 124, an interconnection bus 126, one or more temperature sensors 130, a thermal management unit 132, and a thermal power envelope (TPE) component 134. The second SoC 104 may include a 5G modem processor 152, a power management unit 154, an interconnection bus 164, a plurality of mmWave transceivers 156, memory 158, and various additional processors 160, such as an applications processor and packet processor.

Each processor 110, 112, 114, 116, 118, 121, 122, 152, and 160 may include one or more cores, and each processor/core may perform operations independent of the other processors/cores. For example, the first SoC 102 may include a processor that executes a first type of operating system (e.g., FreeBSD, LINUX, OS X) and a processor that executes a second type of operating system (e.g., MICROSOFT WINDOWS 11). In addition, any or all of the processors 110, 112, 114, 116, 118, 121, 122, 152, and 160 may be included as part of a processor cluster architecture (e.g., a synchronous processor cluster architecture, an asynchronous or heterogeneous processor cluster architecture).

Any or all of the processors 110, 112, 114, 116, 118, 121, 122, 152, and 160 may operate as the CPU of the computing device. In addition, any or all of the processors 110, 112, 114, 116, 118, 121, 122, 152, and 160 may be included as one or more nodes in one or more CPU clusters. A CPU cluster may be a group of interconnected nodes (e.g., processing cores, processors, SoCs, SiPs, computing devices) configured to work in a coordinated manner to perform a computing task. Each node may run its own operating system and contain its own CPU, memory, and storage. A task assigned to the CPU cluster may be divided into smaller tasks that are distributed across the individual nodes for processing. The nodes may work together to complete the task, with each node handling a portion of the computation. The results of each node’s computation may be combined to produce a final result. CPU clusters are especially useful for tasks that can be parallelized and executed simultaneously, allowing them to complete tasks much faster than a single high-performance computer. In addition, because CPU clusters are made up of multiple nodes, they are often more reliable and less prone to failure than a single high-performance component.

The first and second SoCs 102 and 104 may include various system components, resources, and custom circuitry for managing sensor data, analog-to-digital conversions, wireless data transmissions, and performing other specialized operations, such as decoding data packets and processing encoded audio and video signals for rendering in a web browser. For example, the system components and resources 124 of the first SoC 102 may include power amplifiers, voltage regulators, oscillators, phase-locked loops, peripheral bridges, data controllers, memory controllers, system controllers, access ports, timers, and other similar components used to support the processors and software clients running on a computing device. The system components and resources 124 may also include circuitry to interface with peripheral devices, such as cameras, electronic displays, wireless communication devices, and external memory chips.

The first and/or second SoCs 102 and 104 may further include an input/output module (not illustrated) for communicating with resources external to the SoC, such as the clock 106, the voltage regulator 108, the wireless transceiver 166 (e.g., cellular wireless transceiver, Bluetooth transceiver), the camera 168, and user input devices 170 (e.g., a touch-sensitive display, a touchpad, a mouse). Resources external to the SoC (e.g., clock 106, voltage regulator 108, wireless transceiver 166) may be shared by two or more of the internal SoC processors/cores. Further, the first and/or second SoCs 102 and 104 may be configured with modules for processing data received from the camera 168 and user input devices 170. In addition to the example SIP 100 discussed above, various embodiments may be implemented in various computing systems, including a single processor, multiple processors, multicore processors, or any combination thereof.

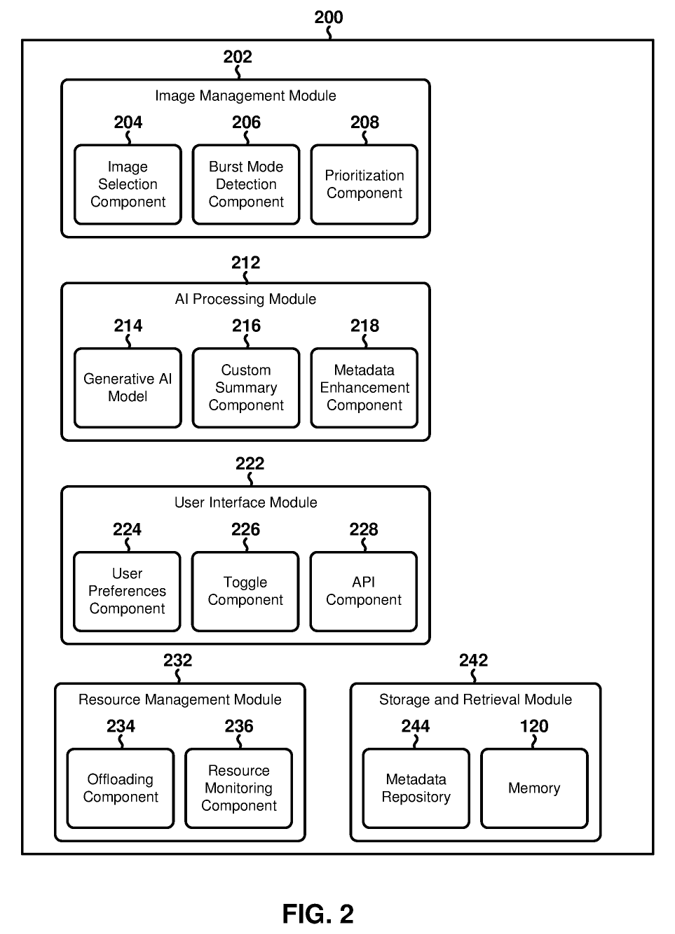

FIG. 2 illustrates example components that could be included in a system configured to implement the various embodiments. With reference to FIGS. 1 and 2, a system 200 (e.g., SIP 100, SOCs 102, 104, etc.) may include one or more of an image management module 202, an AI processing module 212, a user interface module 222, a resource management module 232, and a storage and retrieval module 242. The image management module 202 may include an image selection component 204, a burst mode detection component 206, and a prioritization component 208. The AI processing module 212 may include a generative AI model 214, a custom summary component 216, and a metadata enhancement component 218. The user interface module 222 may include a user preferences component 224, a toggle component 226, and an application programming interface (API) component 228. The resource management module 232 may include an offloading component 234 and a resource monitoring component 236. The storage and retrieval module 242 may include a metadata repository 244 and a memory 120.

The image selection component 204 may be configured to select images from a plurality of images stored on the device. In some embodiments, the image selection component 204 may be configured to select the images based on a priority value associated with the images. In some embodiments, the image selection component 204 may be configured to use various criteria (e.g., recent captures, user interactions, context-based triggers, etc.) to prioritize the images that are processed first. For example, the image selection component 204 may identify images captured during significant events such as birthdays or holidays and prioritize them for processing. In addition, the image selection component 204 may analyze user behavior, such as frequently viewed or shared images, to determine the images that hold higher importance to the user. The image selection component 204 may also consider contextual information (e.g., location and time of capture, etc.) to enhance the selection process so that images most relevant to the user’s interests and activities are processed first.

The burst mode detection component 206 may be configured to identify burst mode images and group them into series. In some embodiments, the burst mode detection component 206 may use metadata and image analysis techniques to detect a series of images captured in quick succession and categorize them appropriately for further processing. For example, the burst mode detection component 206 may analyze the timestamps of images to determine the intervals between captures and identify clusters of images taken within short timeframes as burst mode series. In addition, the burst mode detection component 206 may evaluate visual similarities between images (e.g., consistent backgrounds or subjects, etc.) to more accurately confirm and group burst mode images.

The prioritization component 208 may be configured to determine the processing priority of selected images. In some embodiments, the prioritization component 208 may analyze various factors such as view frequency, share frequency, presence of high-priority individuals, image quality, and user-defined preferences to assign a priority level to each image. For example, the prioritization component 208 may assign a higher priority to images frequently viewed or shared by the user to indicate their significance. The prioritization component 208 may also use facial recognition technology to prioritize images featuring high-priority individuals (e.g., family members, close friends, etc.). In addition, the prioritization component 208 may evaluate or analyze image quality to prioritize clear and well-composed images over blurry or low-quality ones, etc.

The generative AI model 214 may be configured to analyze selected images and generate summaries. In some embodiments, the generative AI model 214 may implement and use deep learning techniques (e.g., transformers, recurrent neural networks, etc.) to understand the content of images and generate contextually relevant summaries. For example, the generative AI model 214 may analyze the visual elements within an image (e.g., objects, people, scenes, etc.) to create a detailed description, identify and incorporate metadata (e.g., geotags, timestamps, etc.) into the detailed description, and generate a contextually relevant summary. In some embodiments, the generative AI model 214 may use pre-trained language models to produce coherent and natural language summaries that reflect the relationships and interactions depicted in the images.

The generated summaries may be information structures (e.g., strings, vectors, etc.) that include descriptive text, metadata annotations, and contextual tags that may be used to assist in categorizing images based on themes, one or more subjects, or user-defined criteria. These summaries may provide a coherent narrative or description of the image content that captures important elements such as the identities of individuals, objects, activities, locations, and events depicted in the image. In some embodiments, the summaries may include semantic information extracted from the image (e.g., emotional tone, notable features, etc.).

The custom summary component 216 may be configured to customize the generated summaries (or generate customized summaries) based on user-specific information. Customized summaries may be information structures (e.g., strings, vectors, etc.) that incorporate individualized elements that are tailored to a specific context and/or user preferences. These information structures may include, for example, descriptive text that reflects the user’s relationship with the one or more subjects in the images (e.g., mentioning family members by name, noting significant events in the user’s life, etc.).

In some embodiments, the custom summary component 216 may be configured to generate customized summaries based on user profiles, historical data, and contextual information. For example, the custom summary component 216 may analyze past user interactions with similar images to identify patterns in how the user describes and organizes their photos. The custom summary component 216 may use facial recognition techniques to identify known individuals and incorporate specific details that the user frequently emphasizes. The custom summary component 216 may provide more relevant and meaningful descriptions by tailoring the generated summaries to reflect the user’s unique way of recalling and categorizing memories. For example, instead of a generic “birthday party,” the summary may note “John’s birthday celebration,” highlighting the specific details that resonate with the user.

The metadata enhancement component 218 may be configured to update the generated customized summaries based on existing metadata. In some embodiments, the metadata enhancement component 218 may improve the accuracy of the analysis by using metadata (e.g., geotags, timestamps, social media descriptions, etc.) to provide additional context for each image. For example, the metadata enhancement component 218 may analyze geotags to determine the location in which an image was captured, cross-reference timestamps to identify events or time periods, incorporate social media descriptions to add contextual details, etc.

The user preferences component 224 may be configured to allow users to set preferences for image analysis and summarization. In some embodiments, the user preferences component 224 may provide a user interface through which users can prioritize or exclude certain types of images based on their content or context. For example, the user preferences component 224 may allow users to select specific categories of images (e.g., family photos, vacation pictures, etc.) for priority processing. In addition, the user preferences component 224 may allow users to exclude images considered private or sensitive (i.e., so that those images are not analyzed or summarized, etc.).

The toggle component 226 may be configured to provide toggles within the user interface to select or exclude images from analysis. In some embodiments, the toggle component 226 may allow users to dynamically adjust the images that are selected from processing and/or otherwise provide users with fine-grain control over the summarization process. For example, the toggle component 226 may provide options to include or exclude images based on specific criteria such as date ranges, locations, or events. Users may also have the ability to manually mark individual images for inclusion or exclusion so that the most relevant or desired images are prioritized for analysis. As such, the toggle component 226 may allow users to better manage their image collections/libraries and customize the summarization operations to their specific preferences.

The API component 228 may be configured to expose the metadata and summaries to third-party applications. In some embodiments, the API component 228 may provide an API that allows external applications to access and use the enhanced metadata and generated summaries (e.g., for searching, sharing, etc.). For example, the API component 228 may allow photo-sharing apps to retrieve and display contextually rich summaries alongside images, provide detailed descriptions and contextual information regarding the images, etc. As another example, the API component 228 may allow social media platforms to integrate advanced search functionalities that allow users to find images based on specific metadata attributes or summary content.

The offloading component 234 may be configured to identify nearby devices with more robust processing capabilities and offload image processing tasks to these devices. In some embodiments, the offloading component 234 may use local network connections to transfer high-priority images to more powerful devices to conserve battery life and/or improve processing efficiency. For example, the offloading component 234 may detect a nearby laptop or desktop computer via Wi-Fi or Bluetooth and transfer image processing tasks to the detected device. Such offloading may reduce the load on the user's mobile device to extend its battery life and speed up the processing of high-priority images.

The resource monitoring component 236 may be configured to continuously or repeatedly monitor the availability and use of battery life and processing power. In some embodiments, the resource monitoring component 236 may adjust the processing schedule and defer non-critical tasks to maintain a balance between performance and resource consumption. For example, the resource monitoring component 236 may analyze the current battery level and CPU usage to determine whether the device is under heavy load or running low on power. In response, the resource monitoring component 236 may prioritize more important or high-priority image processing tasks and/or de-prioritize less important processing tasks (e.g., background metadata updates, low-priority image analysis, etc.).

The metadata repository 244 may be configured to store the updated metadata and generated summaries. In some embodiments, the metadata repository 244 may be accessible by other applications that retrieve and use the enhanced metadata. For example, the metadata repository 244 may allow photo organization apps to access detailed image descriptions and contextual information for more efficient sorting and searching of images. In addition, social media platforms may use the metadata repository 244 to retrieve enriched metadata for better content categorization and user engagement.

The memory 120 may be configured to store selected images and associated metadata. In some embodiments, the memory 120 may provide the necessary storage capacity to manage the large volume of images and metadata generated by the system.

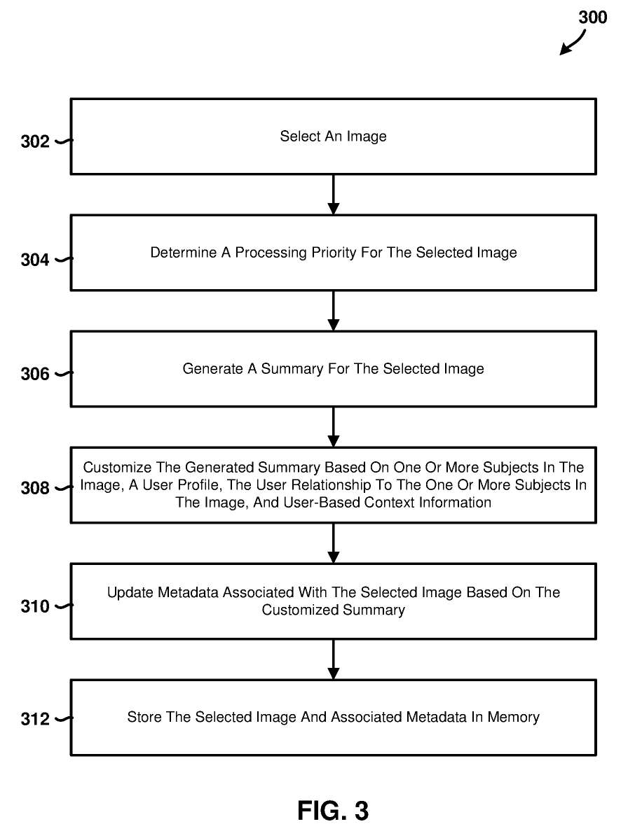

FIG. 3 illustrates a method 300 of analyzing and managing images in accordance with some embodiments. With reference to FIGS. 1-3, the method 300 may be performed in a computing device by a processing system encompassing one or more processors (e.g., 110, 112, 114, 116, 118, 121, 122, 152, 160, etc.), components or subsystems discussed in this application. Means for performing the functions of the operations in the method 300 may include a processing system including one or more of processors 110, 112, 114, 116, 118, 121, 122, 152, 160, and other components described herein. Further, one or more processors of a processing system may be configured with software or firmware to perform some or all of the operations of the method 300. In order to encompass the alternative configurations enabled in various embodiments, the hardware implementing any or all of the method 300 is referred to herein as a “processing system.

In block 302, the processing system may select an image from a plurality of images. For example, the processing system may access the internal storage of the computing device (e.g., memory 120, etc.) or connected cloud storage services to retrieve image files. In some embodiments, the processing system may use APIs or file system calls to locate and select images based on various criteria, such as recent captures, user interactions, and context-based triggers. In some embodiments, the processing system may be configured to select the image based on a result of analyzing metadata (e.g., timestamps, geotags, etc.) to identify images captured during significant events or frequently accessed by the user.

In block 304, the processing system may determine a processing priority for the selected image. For example, the processing system may analyze the metadata associated with the selected image (e.g., view frequency, share frequency, presence of high-priority individuals, etc.). In some embodiments, the processing system may determine the processing priority based on metadata (e.g., time, date, location, facial recognition data, etc.) and any of a variety of additional factors, such as the image's usage as a contact picture, its inclusion in significant events, the importance of relationships depicted in the photos, usage by other mobile device apps, edit history, album saves, image quality, social media descriptions, previous AI summarization queries, common queries applied to similar photos, the frequency with which the image is accessed or interacted with, the presence of specific subjects or themes that are of personal significance to the user, integration with other applications on the device, the relevance of the image to recent or ongoing events, etc. The processing system may also consider user-defined preferences and settings, such as preferences for certain types of images or exclusion of particular content, etc.

In block 306, the processing system may generate a summary for the selected image. In some embodiments, the processing system may query a generative AI model to analyze the image content and context. The AI model may detect and recognize faces, objects, and activities within the image, generate a detailed summary that includes descriptive text, metadata annotations, and contextual tags that could be used for categorizing the image based on themes, subjects, user-defined criteria, etc., and send the detailed summary back in a query response for use as the generated summary. For example, the processing system may query the AI model with metadata such as geotags, timestamps, and user interactions, and the AI model may respond with a detailed summary that includes descriptions of the identified subjects and activities, contextual information about the location and time of the capture, and relevant tags that facilitate easier categorization and retrieval of the image.

In block 308, the processing system may customize the generated summary to provide a customized summary of images based on one or more subjects in the image, a user profile, the user's relationship to the one or more subjects in the image, and user-based context information. For example, the processing system may analyze past user interactions with similar images to identify patterns in how the user describes and organizes their photos. The processing system may use facial recognition techniques to identify known individuals and incorporate specific details that the user frequently emphasizes. The customized summary may characterize the way in which the user recalls and categorizes memories (e.g., noting “John’s birthday celebration” instead of a generic “birthday party,” etc.).

In some embodiments, the processing system may use metadata and relationship information to personalize the summaries in block 308. For example, the processing system may use metadata (e.g., time, date, and location of the image, etc.) and facial recognition data to identify and name individuals in the photo. If the image shows a family gathering at a specific location, the summary may include “Family reunion at Grandma’s house on July 4th, 2023,” instead of a generic description such as “a group of people at a house.”

In some embodiments, the processing system may integrate information from other mobile apps to further enhance the image metadata. For example, if a user posts a photo on social media with the caption “Beach party in La Jolla,” the processing system may retrieve this caption and incorporate it into the generated summary or the image’s metadata. In some embodiments, the processing system may focus on personalized phrasing to enhance the relevance of the summaries to the end user. For example, if the image is of the user’s son on his birthday, the system may generate a summary like “A picture of your son on his 10th birthday,” instead of a generic “A boy celebrating a birthday.” In some embodiments, the processing system may be configured to provide users with highly personalized and contextually robust summaries that describe the image content and align with the way the individual user recalls and organizes memories.

In block 310, the processing system may update metadata associated with the selected image based on the customized summary. For example, the processing system may append the generated summary to the existing metadata to enhance it with additional context and descriptive information. The updated metadata may include, for example, enhanced geotags, timestamps, and social media descriptions that provide a more comprehensive understanding of the image content.

In block 312, the processing system may store the selected image and associated metadata in memory. For example, the processing system may save the updated image file in conjunction with its associated updated metadata in the device's internal storage or connected cloud storage services.

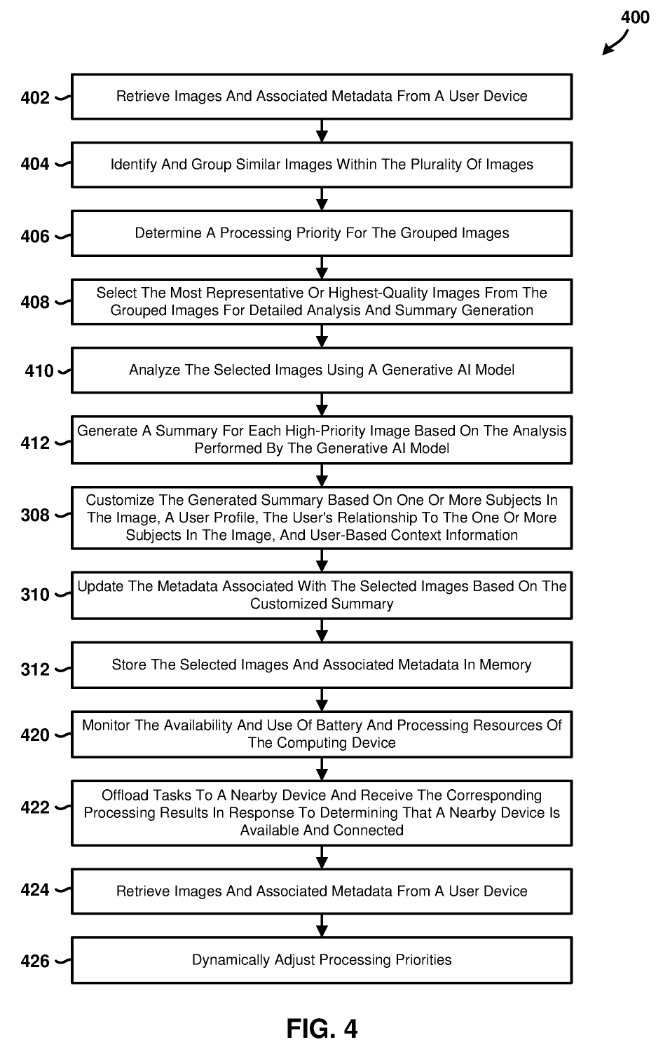

FIG. 4 illustrates a method 400 of analyzing and managing images in accordance with some embodiments. With reference to FIGS. 1-4, the method 400 may be performed in a computing device by a processing system encompassing one or more processors (e.g., 110, 112, 114, 116, 118, 121, 122, 152, 160, etc.), components or subsystems discussed in this application. Means for performing the functions of the operations in the method 400 may include a processing system including one or more of processors 110, 112, 114, 116, 118, 121, 122, 152, 160, and other components described herein. Further, one or more processors of a processing system may be configured with software or firmware to perform some or all of the operations of the method 400. In order to encompass the alternative configurations enabled in various embodiments, the hardware implementing any or all of the method 400 is referred to herein as a “processing system.

In block 402, the processing system may retrieve a plurality of images and associated metadata from a user device. For example, the processing system may access the internal storage of the computing device or a connected cloud storage service to retrieve image files. The processing system may use APIs or file system calls to locate and retrieve images and their associated metadata, such as Exchangeable Image File Format (EXIF) data, geotags, timestamps, and user annotations. The processing system may be configured to handle various image formats (e.g., JPEG, PNG, etc.) and metadata standards. In some embodiments, the processing system may scan specific directories known to store images (e.g., camera roll folders, photo library directories, application-specific storage locations, etc.).

In block 404, the processing system may identify and group similar images within the plurality of images. For example, the processing system may analyze the timestamps of each image to detect sequences of images taken within a short time frame, use metadata tags recorded by the camera or device, and evaluate the visual content of the images to identify consistent backgrounds, one or more subjects in the images, camera settings, etc. In some embodiments, the processing system may group the images so they may be analyzed as a cohesive set rather than as independent, unrelated images.

In block 406, the processing system may determine a processing priority for the grouped images. As part of these operations, the processing system may evaluate various factors such as metadata, frequency of views, shares, presence of high-priority individuals (e.g., contacts, frequently called persons, etc.), presence of specific image types previously queried by the user, usage of each digital image as a contact picture or within significant events, edit history, album saves, image quality, image details, social media descriptions, and other relevant criteria. The processing system may prioritize high-quality images, frequently accessed images, and images with significant contextual metadata.

In block 408, the processing system may select the most representative or highest-quality images from the grouped images for detailed analysis and summary generation. In some embodiments, the selection may be based on image sharpness, focus, exposure, the presence of important subjects or events, and user interactions (e.g., images that have been favorited, viewed frequently, shared, etc.). By selecting the best images, the processing system may reduce the computational workload and improve the efficiency of the image analysis operations.

In block 410, the processing system may analyze the selected images using a generative AI model. In some embodiments, the analysis may include detecting and recognizing faces, objects, and activities within the images, extracting relevant metadata (e.g., geolocation, timestamps), and analyzing the visual characteristics of each image (e.g., brightness, contrast, and color balance). The processing system may also cross-reference contextual information from related images and videos to generate robust analysis results that are detailed and contextually relevant.

In block 412, the processing system may generate a summary for each high-priority image based on the analysis performed by the generative AI model. The summary may include descriptive text, metadata annotations, and contextual tags that could be used to categorize the image based on themes, subjects, user-defined criteria, etc. The processing system may query the AI model with metadata such as geotags, timestamps, and user interactions, and the AI model may respond with a detailed summary that includes descriptions of the identified subjects and activities, contextual information about the location and time of the capture, and relevant tags that facilitate easier categorization and retrieval of the image.

In block 308, the processing system may perform operations in numbered block 308 of method 300 as described. For example, the processing system may customize the generated summary to provide a customized summary based on one or more subjects in the image, a user profile, the user's relationship to the one or more subjects in the image, and user-based context information. The processing system may analyze past user interactions with similar images to identify patterns in how the user describes and organizes their photos. The processing system may use facial recognition techniques to identify known individuals and incorporate specific details that the user frequently emphasizes. The customized summary may characterize the way in which the user recalls and categorizes memories (e.g., noting “John’s birthday celebration” instead of a generic “birthday party”).

In block 310, the processing system may perform operations in numbered block 310 of method 300 as described. For example, the processing system may update the metadata associated with the selected images based on the customized summary. The processing system may append the generated summary to the existing metadata to enhance it with additional context and descriptive information. The updated metadata may include enhanced geotags, timestamps, and social media descriptions that provide a more comprehensive understanding of the image content.

In block 312, the processing system may perform operations in numbered block 312 of method 300 as described. For example, the processing system may store the selected images and associated metadata in memory. The processing system may save the updated image file in conjunction with its associated updated metadata in the device's internal storage or connected cloud storage services. The updated metadata may be stored in a metadata repository accessible by other applications, and an exposed API may be provided that third-party applications may use to access and use the images, metadata, and summaries.

In block 420, the processing system may monitor the availability and use of battery and processing resources of the computing device. The processing system may adjust processing schedules to balance tradeoffs between performance and resource consumption based on the result of the monitoring for efficient utilization of available resources and reduced delays in image analysis tasks.

In block 422, the processing system may offload tasks to a nearby device and receive the corresponding processing results in response to determining that a nearby device is available and connected. For example, the processing system may use Bluetooth, WiFi, or other connection technologies to detect the presence of nearby devices and trigger a wireless connection to share images for processing. This may allow for the efficient use of computing power while maintaining performance standards.

In block 424, the processing system may dynamically adjust processing priorities based on various factors such as metadata analysis, frequency of views and shares, presence of high-priority individuals or specific image types previously queried by the user, and available resources within the device or nearby networked devices.

In block 426, the processing system may dynamically adjust processing priorities based on various factors such as metadata analysis, frequency of views and shares, presence of high-priority individuals or specific image types previously queried by the user, and available resources within the device or nearby networked devices.

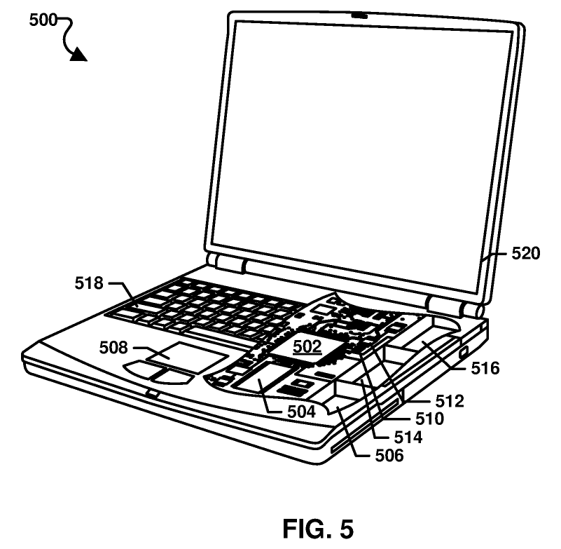

Various embodiments (including, but not limited to, embodiments described above with reference to FIGS. 1-4) may be implemented in a wide variety of wireless devices and computing systems including a laptop computer 500, an example of which is illustrated in FIG. 5. With reference to FIGS. 1-5, a laptop computer may include a processing system 502 coupled to volatile memory 504 and a large capacity nonvolatile memory, such as a disk drive 506 or Flash memory. The laptop computer 500 may include a touchpad touch surface 508 that serves as the computer’s pointing device, and thus may receive drag, scroll, and flick gestures. In addition, the laptop computer 500 may have one or more antenna 510 for sending and receiving electromagnetic radiation that may be connected to a wireless data link and/or cellular telephone transceiver 512 coupled to the processing system 502. The computer 500 may also include a BT transceiver 514, a compact disc (CD) drive 516, a keyboard 518, and a display 520 all coupled to the processing system 502. Other configurations of the computing device may include a computer mouse or trackball coupled to the processing system (e.g., via a universal serial bus (USB) input) as are well known, which may also be used in conjunction with various embodiments.

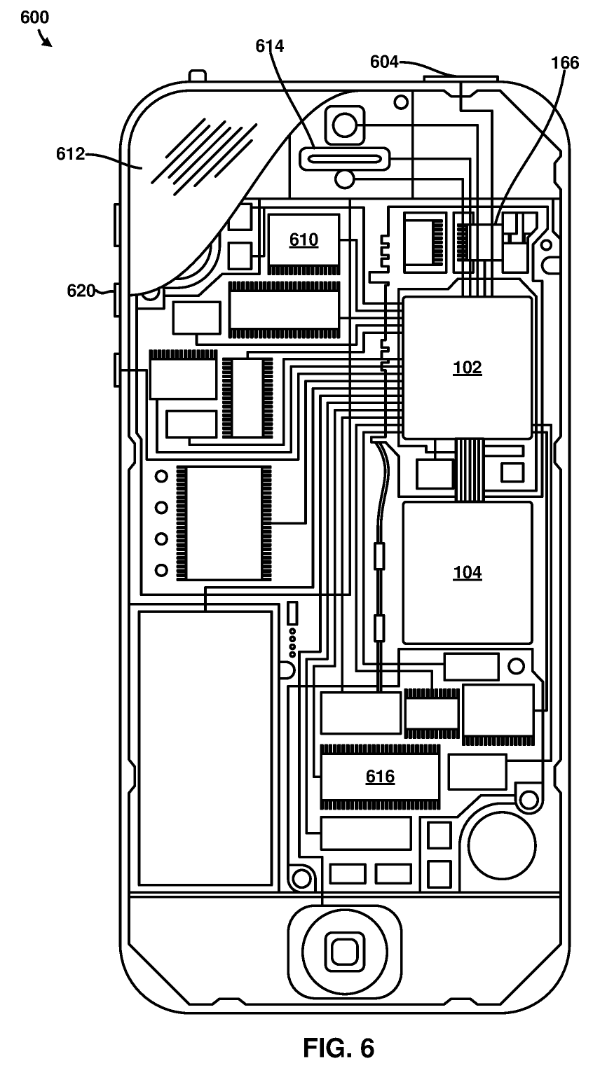

FIG. 6 is a component block diagram of a computing device 600 suitable for use with various embodiments. With reference to FIGS. 1–6, various embodiments may be implemented on a variety of computing devices 600, an example of which is illustrated in FIG. 6 in the form of a smartphone. The computing device 600 may include a first SOC 102 coupled to a second SOC 104. The first and second SoCs 102, 104 may be coupled to internal memory 616, a touch-sensitive display 612, a camera 168, and a speaker 614. The first and second SOCs 102, 104 may also be coupled to at least one subscriber identity module (SIM) 640 and/or a SIM interface that may store information supporting a first 5GNR subscription and a second 5GNR subscription, which support service on a 5G non-standalone (NSA) network.

The computing device 600 may include an antenna 604 for sending and receiving electromagnetic radiation that may be connected to a wireless transceiver 166 coupled to one or more processors in the first and/or second SOCs 102, 104. The computing device 600 may also include menu selection buttons or rocker switches 620 for receiving user inputs.

The computing device 600 also includes a sound encoding/decoding (CODEC) circuit 610, which digitizes sound received from a microphone into data packets suitable for wireless transmission and decodes received sound data packets to generate analog signals that are provided to the speaker to generate sound. Also, one or more of the processors in the first and second circuitries 102, 104, wireless transceiver 166, and CODEC 610 may include a digital signal processor (DSP) circuit (not shown separately).

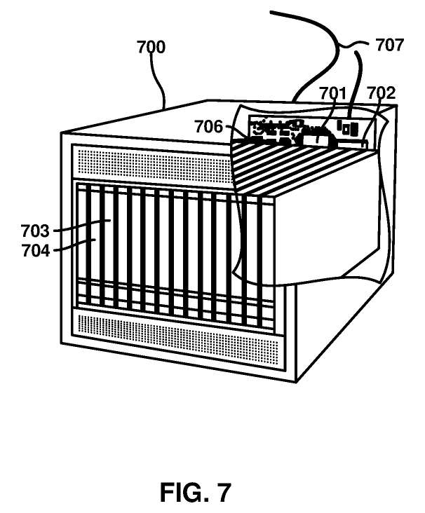

Some embodiments may be implemented on a variety of commercially available computing devices, such as the server computing device 700 illustrated in FIG. 7. The server device 700 may include a multi-core processor 701 coupled to volatile memory 702, such as RAM, and a large capacity nonvolatile memory, such as a solid-state drive 703. The server device 700 may also include additional storage interfaces such as USB ports and NVMe slots coupled to the processor 701. The server device 700 may include network access ports 706 coupled to the processor 701, enabling data connections through a network interface card 704 and a communication network 707 (e.g., an Internet Protocol (IP) network) connected to other network elements.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within a first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A computing device, including a processor configured to: select an image from a plurality of images; determine a processing priority for the selected image; generate a summary for the selected image; customize the generated summary to provide a customized summary based on one or more subjects in the image, a user profile, user relationships to the one or more subjects in the image, and user-based context information; update metadata associated with the selected image based on the customized summary; and store the selected image and associated metadata in memory.

Example 2. The computing device of example 1, in which the processor is configured to determine the processing priority for the selected image based on one or more of: metadata associated with the selected image, frequency of views, frequency of shares, presence of high-priority individuals, presence of specific image types previously queried by a user, usage of each digital image as a contact picture or within significant events, edit history, album saves, image quality, image details, or social media descriptions.

Example 3. The computing device of either of examples 1 or 2, in which the processor is configured to generate the summary for the selected image by querying or prompting a generative AI model.

Example 4. The computing device of example 3, in which the processor is further configured to: receive query results from the generative AI model in response to querying or prompting the generative AI model; determine whether existing metadata is available for the selected image; and enhance the received query results based on the existing metadata.

Example 5. The computing device of example 3, in which the processor is configured to query or prompt the generative AI model by querying or prompting a remote generative AI model.

Example 6. The computing device of example 3, in which the processor is configured to query the generative AI model by querying or prompting a local generative AI model.

Example 7. The computing device of any of examples 1-6, in which the processor is configured to customize the generated summary further based on one or more of: metadata associated with the selected image, frequency of views, frequency of shares, presence of high-priority individuals, presence of specific image types previously queried by a user, usage of each digital image as a contact picture or within significant events, edit history, album saves, image quality, image details, or social media descriptions.

Example 8. The computing device of any of examples 1-7, in which the processor is further configured to: receive a user-generated query about a specific image; and customize the generated summary further based on the received user-generated query.

Example 9. The computing device of any of examples 1-8, in which the processor is further configured to: identify and group similar images; identify redundant images in the grouped images; determine the processing priority for the selected image and generate the summary for the selected image in response to determining that the selected image is not a redundant image; and not determine a processing priority for the selected image or generate the summary for the selected image in response to determining that the selected image is a redundant image.

Example 10. The computing device of any of examples 1-9, in which, in response to determining that a nearby device is available and connected, the processor is further configured to offload tasks to the nearby device and receive corresponding processing results.

Example 11. The computing device of any of examples 1-10, in which the processor is further configured to: monitor availability and use of battery and processing resources of the computing device; and adjust processing schedules to balance tradeoffs between performance and resource consumption based on a result of the monitoring.

Example 12. A method of managing and analyzing digital images in a computing device, including: selecting an image from a plurality of images; determining a processing priority for the selected image; generating a summary for the selected image; customizing the generated summary to provide a customized summary based on one or more subjects in the image, a user profile, user relationships to the one or more subjects in the image, and user-based context information; updating metadata associated with the selected image based on the customized summary; and storing the selected image and associated metadata in memory.

Example 13. The method of example 12, further including determining the processing priority for the selected image based on one or more of: metadata associated with the selected image, frequency of views, frequency of shares, presence of high-priority individuals, presence of specific image types previously queried by a user, usage of each digital image as a contact picture or within significant events, edit history, album saves, image quality, image details, or social media descriptions.

Example 14. The method of either of examples 12 or 13, further including: prompting a generative artificial intelligence (AI) model to generate the summary for the selected image; receiving results from the generative AI model; determining whether existing metadata is available for the selected image; and enhancing the received query results based on the existing metadata.

Example 15. The method of example 14, in which prompting the generative AI model includes prompting a generative AI model executing in the computing device.

Example 16. The method of example 14, in which prompting the generative AI model includes prompting a remote generative AI model.

Example 17. The method of any of examples 12-16, in which customizing the generated summary to provide a custom summary is further based on one or more of: metadata associated with the selected image, frequency of views, frequency of shares, presence of high-priority individuals, presence of specific image types previously queried by a user, usage of each digital image as a contact picture or within significant events, edit history, album saves, image quality, image details, or social media descriptions.

Example 18. The method of any of examples 12-17, further including: receiving a user-generated query about a specific image; and customizing the generated summary further based on the received user-generated query.

Example 19. The method of any of examples 12-18, further including: identifying and grouping similar images; identifying redundant images in the grouped images; determining the processing priority for the selected image and generating the summary for the selected image in response to determining that the selected image is not a redundant image; and not determining a processing priority for the selected image or generating the summary for the selected image in response to determining that the selected image is a redundant image.

Example 20. The method of any of examples 12-19, further including: monitoring availability and use of battery and processing resources of the computing device; and adjusting processing schedules to balance tradeoffs between performance and resource consumption based on a result of the monitoring.

Example 21. A non-transitory processor-readable medium having stored thereon processor-executable instructions configured to cause a processing system of a computing device to perform operations of the methods of any of examples 12 to 20.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function or procedure calls, electronic signaling, data packet exchanges, and memory interactions, among other known methods of network, computer, processor, or process-related communications.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudo-static random-access memory (PSRAM). Systems and computing devices that implement the various embodiments may also include or use electronic (solid-state) non-volatile computer storage mediums, such as FLASH memory. Each of the above-mentioned memory technologies includes, for example, elements suitable for storing instructions, programs, control signals, and/or data for use in a computing device, system on chip (SOC), or other electronic component. Any references to terminology and/or technical details related to an individual type of memory, interface, or standard memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application-specific integrated circuit (TCUASIC), a field programmable gate array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), non-volatile memory express (NVMe) drives, three-dimensional (3D) NAND flash, or any other medium that may be used to store target program code in the form of instructions or data structures and that may be accessed by a computer. Modern technologies, such as cloud-based storage solutions, including infrastructure-as-a-service (IaaS) platforms, may offer scalable and distributed options for storing and accessing program code. In addition, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing units (GPUs) and tensor processing units (TPUs), may be used to execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
a processor configured to:
select an image from a plurality of images;
determine a processing priority for the selected image;
generate a summary for the selected image;
customize the generated summary to provide a customized summary based on one or more subjects in the image, a user profile, user relationships to the one or more subjects in the image, and user-based context information;
update metadata associated with the selected image based on the customized summary; and
store the selected image and associated metadata in memory.

2. The computing device of claim 1, wherein the processor is configured to determine the processing priority for the selected image based on one or more of:
metadata associated with the selected image,
frequency of views,
frequency of shares,
presence of high-priority individuals,
presence of specific image types previously queried by a user,
usage of each digital image as a contact picture or within significant events,
edit history,
album saves,
image quality,
image details, or
social media descriptions.

3. The computing device of claim 1, wherein the processor is configured to generate the summary for the selected image by querying a generative artificial intelligence (AI) model.

4. The computing device of claim 3, wherein the processor is further configured to:
receive query results from the generative AI model in response to querying the generative AI model;
determine whether existing metadata is available for the selected image; and
enhance the received query results based on the existing metadata.

5. The computing device of claim 3, wherein the processor is configured to query the generative AI model by querying a remote generative AI model.

6. The computing device of claim 3, wherein the processor is configured to query the generative AI model by querying a local generative AI model.

7. The computing device of claim 1, wherein the processor is configured to customize the generated summary further based on one or more of:
metadata associated with the selected image,
frequency of views,
frequency of shares,
presence of high-priority individuals,
presence of specific image types previously queried by a user,
usage of each digital image as a contact picture or within significant events,
edit history,
album saves,
image quality,
image details, or
social media descriptions.

8. The computing device of claim 1, wherein the processor is further configured to:
receive a user-generated query about a specific image; and
customize the generated summary further based on the received user-generated query.

9. The computing device of claim 1, wherein the processor is further configured to:
identify and group similar images;
identify redundant images in the grouped images;
determine the processing priority for the selected image and generate the summary for the selected image in response to determining that the selected image is not a redundant image; and
not determine a processing priority for the selected image or generate the summary for the selected image in response to determining that the selected image is a redundant image.

10. The computing device of claim 1, wherein, in response to determining that a nearby device is available and connected, the processor is further configured to offload tasks to the nearby device and receive corresponding processing results.

11. The computing device of claim 1, wherein the processor is further configured to:
monitor availability and use of battery and processing resources of the computing device; and
adjust processing schedules to balance tradeoffs between performance and resource consumption based on a result of the monitoring.

12. A method of managing and analyzing digital images in a computing device, comprising:
selecting an image from a plurality of images;
determining a processing priority for the selected image;
generating a summary for the selected image;
customizing the generated summary to provide a customized summary based on one or more subjects in the image, a user profile, user relationships to the one or more subjects in the image, and user-based context information;
updating metadata associated with the selected image based on the customized summary; and
storing the selected image and associated metadata in memory.

13. The method of claim 12, further comprising determining the processing priority for the selected image based on one or more of:
metadata associated with the selected image,
frequency of views,
frequency of shares,
presence of high-priority individuals,
presence of specific image types previously queried by a user,
usage of each digital image as a contact picture or within significant events,
edit history,
album saves,
image quality,
image details, or
social media descriptions.

14. The method of claim 12, further comprising:
prompting a generative artificial intelligence (AI) model to generate the summary for the selected image;
receiving results from the generative AI model;
determining whether existing metadata is available for the selected image; and
enhancing the received query results based on the existing metadata.

15. The method of claim 14, wherein prompting the generative AI model comprises prompting a generative AI model executing in the computing device.

16. The method of claim 12, wherein customizing the generated summary to provide the custom summary is further based on one or more of:
metadata associated with the selected image,
frequency of views,
frequency of shares,
presence of high-priority individuals,
presence of specific image types previously queried by a user,
usage of each digital image as a contact picture or within significant events,
edit history,
album saves,
image quality,
image details, or
social media descriptions.

17. The method of claim 12, further comprising:
receiving a user-generated query about a specific image; and
customizing the generated summary further based on the received user-generated query.

18. The method of claim 12, further comprising:
identifying and grouping similar images;
identifying redundant images in the grouped images;
determining the processing priority for the selected image and generating the summary for the selected image in response to determining that the selected image is not a redundant image; and
not determining a processing priority for the selected image or generating the summary for the selected image in response to determining that the selected image is a redundant image.

19. The method of claim 12, further comprising:
monitoring availability and use of battery and processing resources of the computing device; and
adjusting processing schedules to balance tradeoffs between performance and resource consumption based on a result of the monitoring.

20. A non-transitory processor-readable medium having stored thereon processor-executable instructions configured to cause a processing system of a computing device to perform operations comprising:
selecting an image from a plurality of images;
determining a processing priority for the selected image;
generating a summary for the selected image;
customizing the generated summary to provide a customized summary based on one or more subjects in the image, a user profile, user relationships to the one or more subjects in the image, and user-based context information;
updating metadata associated with the selected image based on the customized summary; and
storing the selected image and associated metadata in memory.
